(19) United States
(12) Patent Application Publication
(10) Pub. No.: US 2014/0372913 A1
(43) Pub. Date: Dec. 18, 2014

(54) METHOD OF ORGANIZING AND ACCESSING INFORMATION

(71) Applicant: Steven W. Roth, Woobury, NY (US)

(72) Inventors: Steven W. Roth, Woodbury, NY (US); Jeffrey Barry, Longmeadow, MA (US)

(73) Assignee: Steven W. Roth, Woobury, NY (US)

(21) Appl. No.: 14/071,475

(22) Filed: Nov. 4, 2013

Related U.S. Application Data
(63) Continuation of application No. PCT/US13/46393, filed on Jun. 18, 2013.

(51) Int. Cl. G06F 3/0484

(52) U.S. Cl. CPC G06F 3/0484
USPC 715/760

(57) ABSTRACT

A method of organizing and accessing information on a website, comprising providing a plurality of primary category links associated with a plurality of primary categories, providing a plurality of topic links each associated with one or more art topics, each topic link having a topic name and a topic image, and providing a content region for presenting content for an art topic and having a content type associated with a primary category, wherein navigation around the website may be harmonized by art topic.

### CROSS-REFERENCE TO RELATED APPLICATIONS

This application is a continuation of PCT/US13/46393, filed on Jun. 18, 2013, which claims priority to U.S. Provisional Patent Application No. 61/661,094, filed on Jun. 18, 2012, and U.S. Provisional Patent Application No. 61/716,530, filed Oct. 20, 2012, all of which are incorporated by reference herein.

### FIELD OF THE INVENTION

The present invention relates to a method of organizing and accessing information on a website generally, and more specifically to an exploration of art topics that provides categories of exploration including static content such as articles, dynamic content such as videos, and a social network that allows users to connect and network with each other by category and art topic.

### BACKGROUND

One major challenge in developing a website interface lies in generating a coherent navigation scheme both tied to the content being presented and efficiently organized. To that end, various attempts have been made to generate a navigation scheme for a website containing content organized based on several criteria, such that content sought is easy to find based on traditional navigation methods (using, for example, tiered menu schematics), but may also be accessed from multiple locations within an interface.

When using a traditional menu schematic, a broad category must first be selected, followed by a narrower criteria, which must then be systematically narrowed until specific content is found. Content cannot, however, be easily organized along multiple dimensions (such as, for example, content type, subject matter, and specified user posting, in a social media context). Therefore, once specific content is found, it may be difficult to find content related along a dimension other than that used to access the content in the first place.

There is a need for a content organization and access system for a website that allows content to be approached along multiple dimensions and that ties content together based on multiple organizational schematics. There is a further need for such a system with integrated social networking features.

### SUMMARY

A method of organizing and accessing information on a website, comprising providing a plurality of primary category links associated with a plurality of primary categories, providing a plurality of topic links each associated with one or more art topics, each topic link having a topic name and a topic image, and providing a content region for presenting content for an art topic and having a content type associated with a primary category, wherein navigation around the website may be harmonized by art topic.

### BRIEF DESCRIPTION OF THE DRAWINGS

FIG. 1A illustrates one embodiment of a website in accordance with principles of the present disclosure;

FIG. 1B illustrates one embodiment of a method of accessing the website of FIG. 1A;

FIG. 2 illustrates one embodiment of a category link header region for the articles category;

FIG. 3 illustrates one embodiment of a category link header region for the contests category;

FIG. 4 illustrates one embodiment of a category link header region for the connect category;

FIG. 5 illustrates one embodiment of an articles page;

FIG. 6 illustrates one embodiment of a matrix of art topics;

FIG. 7 illustrates one embodiment of a videos page;

FIG. 8 illustrates one embodiment of an articles page for an animation art topic;

FIG. 9 illustrates one embodiment of an art topic header region;

FIG. 10 illustrates one embodiment of a portion of an arrangement of art topics;

FIG. 11 illustrates one embodiment of a videos page for an animation art topic;

FIG. 12 illustrates one embodiment of an articles page for an architecture art topic;

FIG. 13 illustrates one embodiment of a social network launch page;

FIG. 14 illustrates one embodiment of an all topics stream;

FIG. 15 illustrates one embodiment of a tag stream;

FIG. 16 illustrates one embodiment of a post;

FIG. 17 illustrates one embodiment of a creative stream within a particular art topic;

FIG. 18 illustrates one embodiment of a user profile;

FIG. 19 illustrates one embodiment of a user creative stream;

FIG. 20 illustrates one embodiment of a navigation scheme harmonized by art topic;

FIG. 21 illustrates an alternative embodiment of a website in accordance with principles of the present disclosure;

FIGS. 22-23 illustrate one embodiment of a website in accordance with principles of the present disclosure and showing a mini arrangement of art topics;

FIGS. 24-26 illustrate embodiments of an articles page of a website in accordance with principles of the present disclosure;

FIG. 27 illustrates one embodiment of a website in accordance with principles of the present disclosure and showing a mini arrangement of art topics of articles;

FIG. 28 illustrates an embodiment of an articles page of a website in accordance with principles of the present disclosure;

FIG. 29 illustrates one embodiment of a website in accordance with principles of the present disclosure and showing a mini arrangement of art topics of videos;

FIG. 30 illustrates one embodiment of a website in accordance with principles of the present disclosure and showing a mini arrangement of art topics of social network posts;

FIG. 31 illustrates one embodiment of a website in accordance with principles of the present disclosure and showing a mini arrangement of art topics of job postings; and

FIG. 32 illustrates one embodiment of an interaction between aspects of the website of the present invention, a user and sources of content.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

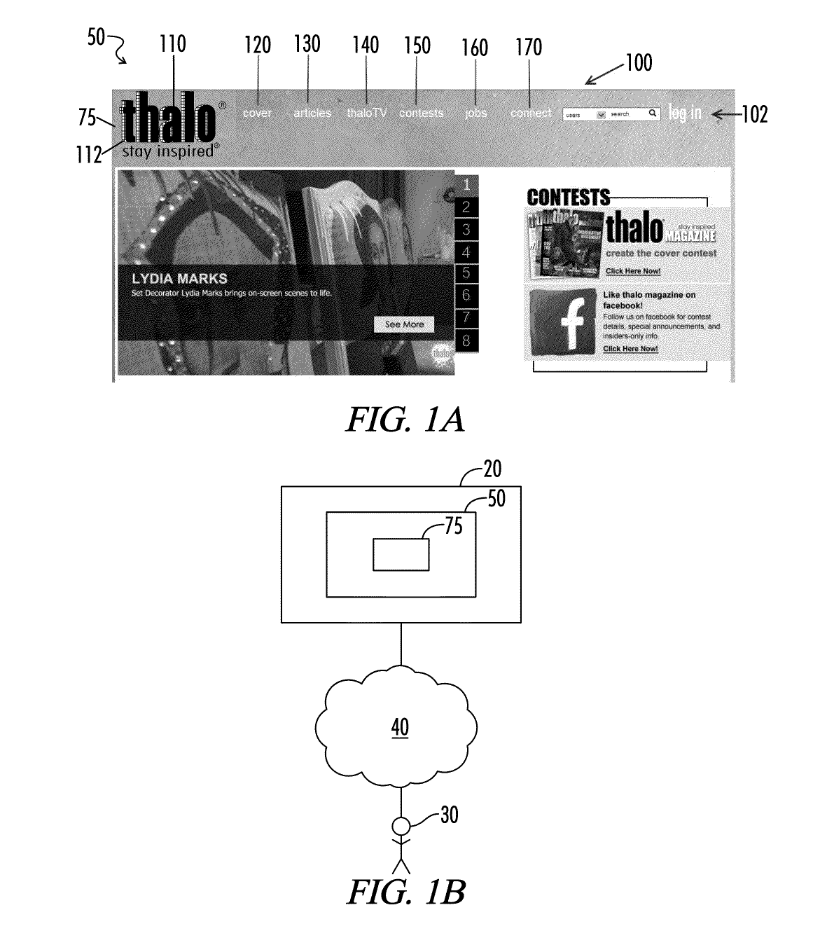

FIG. 1A illustrates one embodiment of a portion of a home page 75 of a website 50 that is operated on a server or the like 20 that is accessed by a user 30 through a network 40 (see FIG. 1B), where the website 50 that will be used for purposes of explaining the method of the present disclosure will be shown as the website of Thalo® magazine found at www.thalo.com. The website is typically operated on a computer system comprising a processing system and one or more computers coupled to the processing system over a network. The website can also be operable through a non-transitory computer-readable medium that stores instructions executable by one or more processors. While one particular website is being used for the purposes of explanation, it will be appreciated that the content and the arrangement of elements is not meant to be limiting, but is meant to be merely illustrative, and that other content or arrangements are possible. Furthermore, while a network 40 is shown, it will be appreciated that any type of local or global network may be used. Furthermore, while a server 20 is shown, it will be appreciate that any type of device may be used without detracting from the functionality of the website 50 or the scope of the present disclosure.

The website 50 of the current embodiment is an exploration of the arts that provides categories of exploration including static content such as articles, dynamic content such as video, various databases of information and events, such as contests and jobs, for example, and a social network that allows users to connect and network with each other. More specifically, the website 50 allows a user to explore content and connect with others regarding a variety of art topics, or regarding a specific topic of particular interest to the user. In other words, a user can navigate through the various categories on the website 50 by a specific topic, view content pertaining to the specific topic, and network with others about the specific topic, without navigating away from the particular topic. This is described in more detail below.

Returning now to FIG. 1A, the home page 75 illustrates a plurality of primary category links 100 shown in the present embodiment as thalo 110, cover 120, articles 130, thaloTV 140, contests 150, jobs 160 and connect 170. The particular primary category links 100 illustrated and described herein are not meant to be limiting, but are only provided for purposes of explanation. In particular:
a. thalo 110 takes the user back to the home page 75 and will, for purposes of convenience, be described from this point forward as a home page link 110,
b. cover 120 takes the user to a cover page 122 that illustrates content (not shown) related to a magazine (not shown) associated with the owner of the website 50,
c. articles 130 takes a user to an articles page 132 for the selection of static content such as articles,
d. thaloTV 140 takes a user to a videos page 142 for the selection of dynamic content such as videos,
e. contests 150 takes the user to a contests page 152 for the selection of contests,
f. jobs 160 takes the user to a jobs page 162 for the selection of jobs, and
g. connect 170 takes the user to a social network via a social network page 172.
   These primary links 100 reside in a primary category link header region 102 that, in the present embodiment, is preferably static or does not change as a user navigates between sub-pages on the website 50.

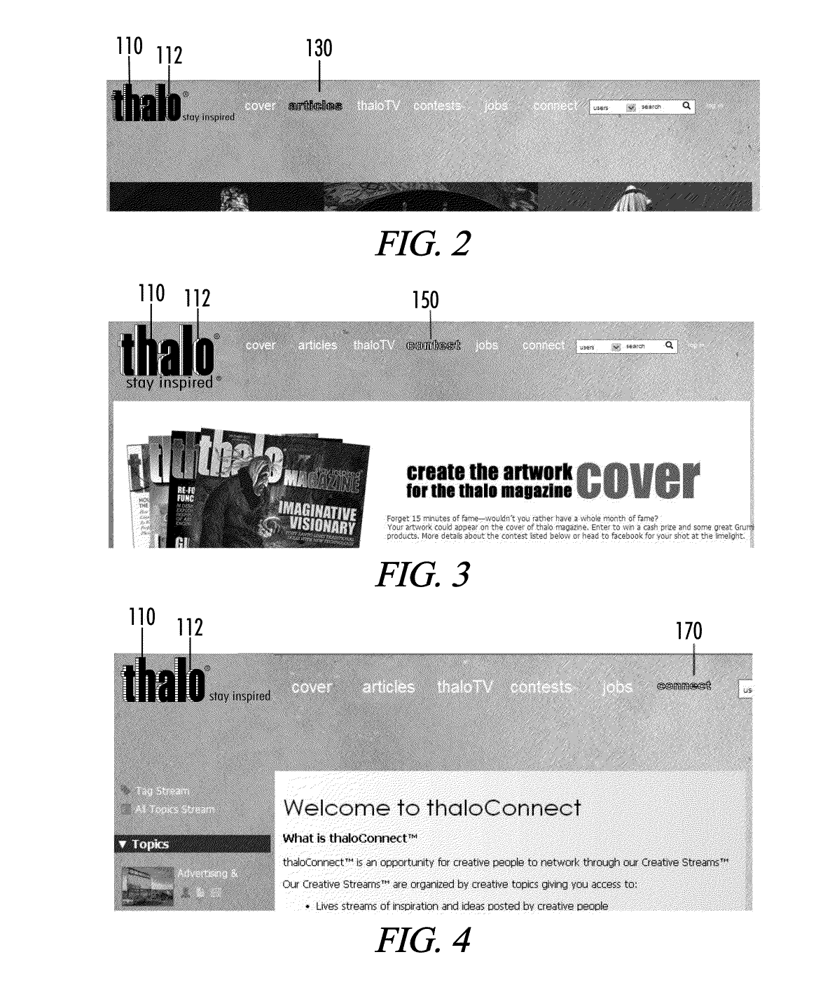

In accordance with one embodiment, the home page link 110 assumes a certain visual characteristic 112 depending on the primary category link 100 selected and/or an associated sub-page related to such primary category link 100. In one example, the home page link 110 has a different color or color outline depending on the primary category link 100 selected. For example, the “thalo” term may have a yellow outline when articles 130 is selected, which preferably results in the “articles” term assuming the same yellow color as the yellow color outline around “thalo” as shown in FIG. 2, or it may have a red outline when contests 150 is selected, which preferably results in the “contests” term assuming the same red color as the red color outline around “thalo” as shown in FIG. 3, or it may have a blue outline when connect 170 is selected, which preferably results in the “connect” term assuming the same blue color as the blue color outline around “thalo” as shown in FIG. 4, and so on. The visual characteristic 112 of the home page link, or in this case a certain color outline, preferably varies with the selection of primary category link so that a user is able to easily ascertain its location relative to a certain primary link. In this example, the selected primary category link assumes a consistent visual characteristic (i.e. colored font) as the visual characteristic of the home page link (i.e. colored outline), although it is possible for the selected primary link to also assume the same visual characteristic, or a colored outline in this case.

Thus, the visual characteristic of color and the manner of expression being a font outline color or a change in font color altogether, can be manifested in a variety of ways with respect to the home page link 110 and selected primary category link. It is preferable for the visual characteristic 112 to be unique to each primary category link so that, for example, the home page link 110 has one unique color outline depending on a particular selection of a primary category link 100. It is also preferable if the visual characteristic is not repeated for different primary category link selections. While a certain color outline is illustrated as the visual characteristic 112, it will be appreciated that other visual characteristics are possible, such as font color, font type, font language, font texture, font case (lowercase or upper case, for example), font size, font appearance (i.e. bold, underline, strikeout, etc.), a toggle between certain fonts or font types, or various combinations of the above. Thus, a user is able to ascertain its location by viewing the primary category link header region 102, and in particular by viewing at least one area, i.e. the selected primary link, or more than one area, i.e. the home page link, either individually or collectively. In this embodiment, the appearance of the home page link 110 reinforces the user's location and the selected primary link 100.

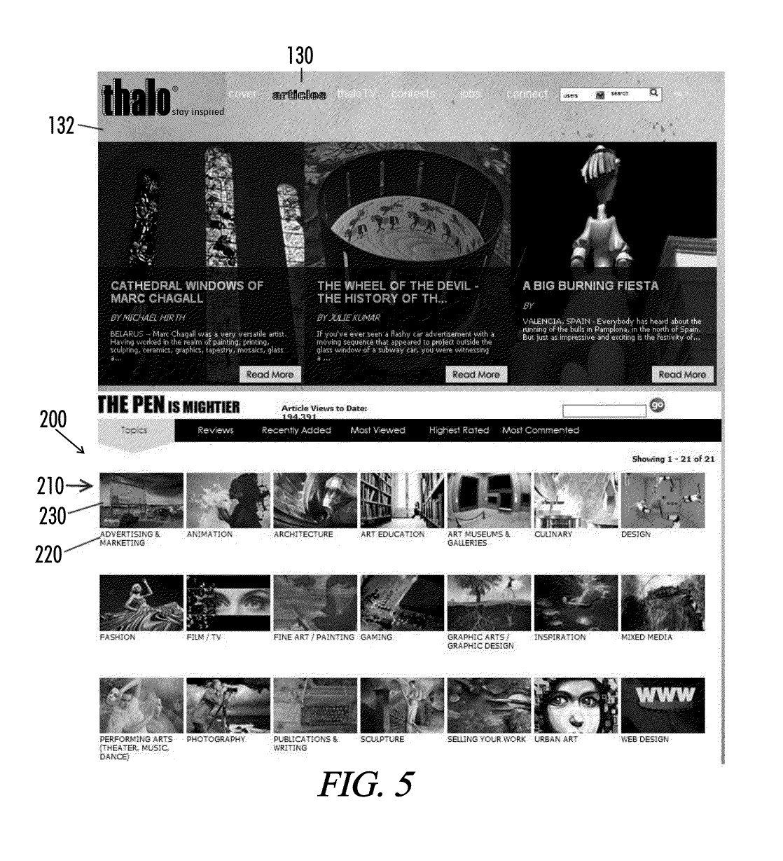

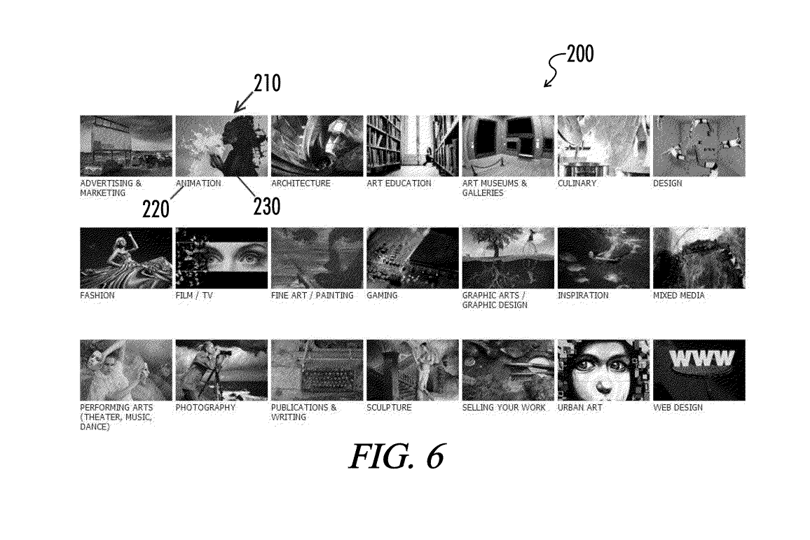

The website 50 of the current embodiment is an exploration of the arts wherein the primary category links 100 represent an organization of content pertaining to a variety of art topics, or regarding a specific topic 210 of interest to the user. FIGS. 5-6 illustrate one embodiment of an arrangement 200 of art topics 210 that might be presented to a user upon the user's selection of a primary category link 100. For example, if a user selects articles 130, then a user would navigate to the articles page 132 (FIG. 5) and be presented with a matrix arrangement 200 of art topics 210 (FIG. 6), each separate art topic being identified by an art topic name 220, or textual element, and an art topic image 230, or visual element. A non-limiting list of art topics 210 includes advertising and marketing, animation, architecture, art education, art museums and galleries, culinary, design, fashion, film and television, fine art and painting, gaming, graphic arts and graphic design, inspiration, mixed media, performing arts (theater, music dance), photography, publications and writing, sculpture, selling your work, urban art and web design. While a matrix arrangement 200 of art topics 210 is shown, it will be appreciated that other arrangement schemes are possible.

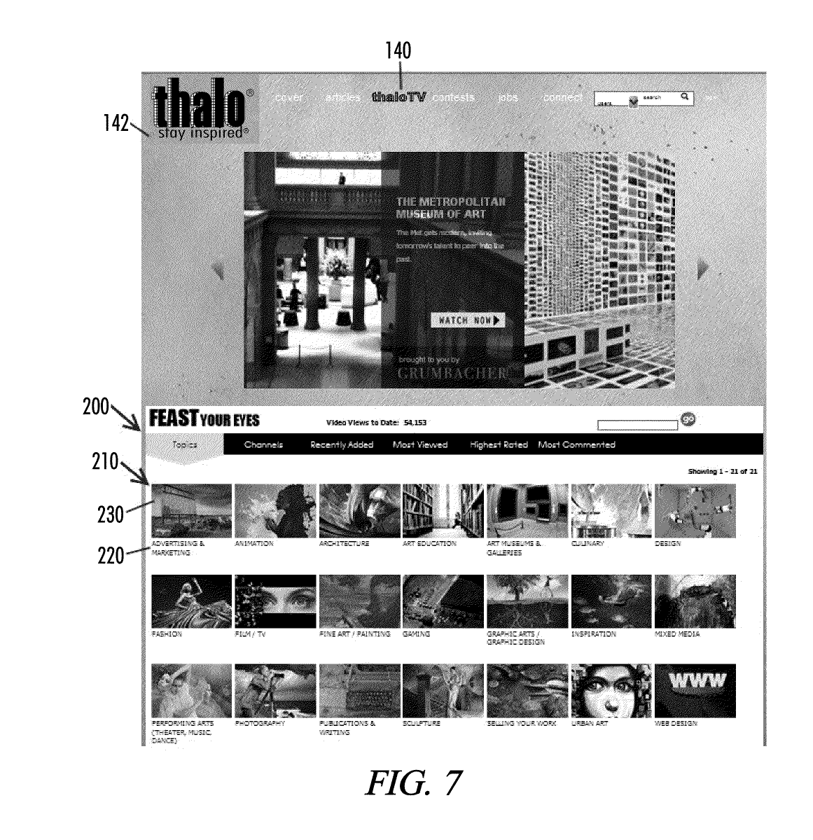

The presentation of art topics 210, and more specifically the topic name 220 and topic image 230, are preferably consistent across categories of primary category links 100. For example, if a user initially selects articles 130, a user will be presented with an arrangement 200 of art topics 210 that is preferably similar to the arrangement 200 of art topics 210 resulting from the user's selection of thaloTV 140 and the navigation to the videos page 142 (FIG. 7), for example. Furthermore, a user is able to recognize the art topics 210 through the presentation of a consistent topic image 230 and topic name 220 across categories, which in effect allows a user to navigate by art topic 210, by topic name 220 and/or topic image 230. Thus, if a user is only interested in one or two art topics 210, the user is able to focus only on one or two topic images 230, and will recognize such topic images 230 within each different primary category link to which they navigate.

While it is preferable that the same arrangement 200 is presented upon the selection of the primary category links 100, it may be that the same arrangement 200 is presented upon the selection of most, but not all of the primary category links 100. For example, if a user selects the primary category link 150 related to contests, a user might not be presented with an arrangement 200 of art topics if the contests category is not segregated by art topic.

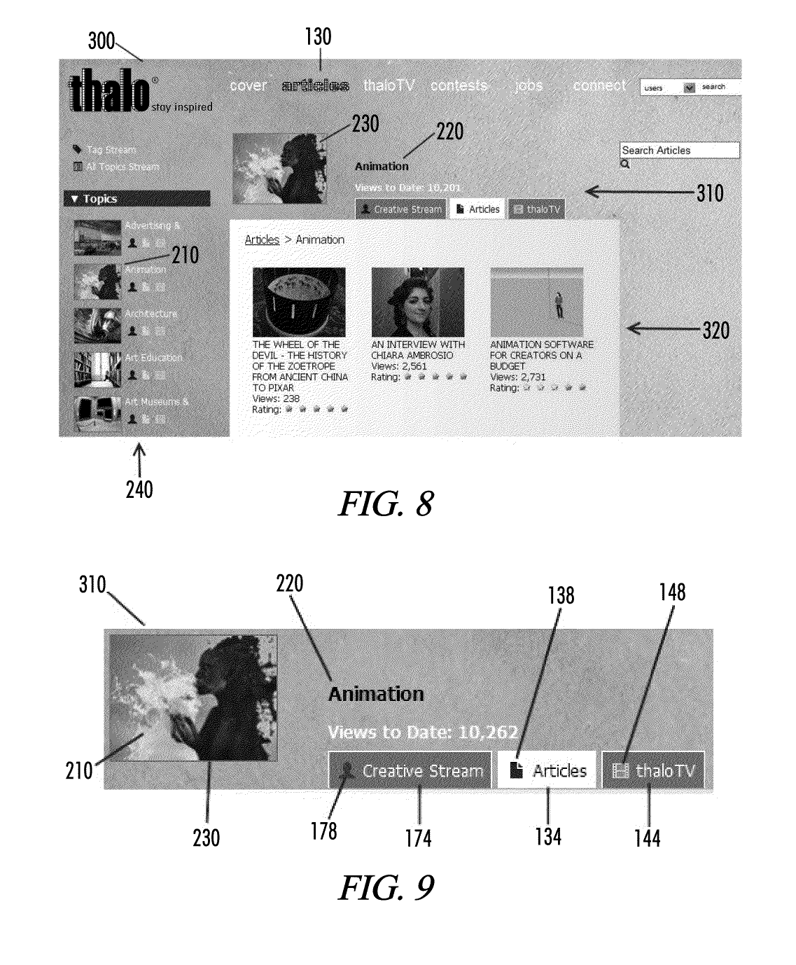

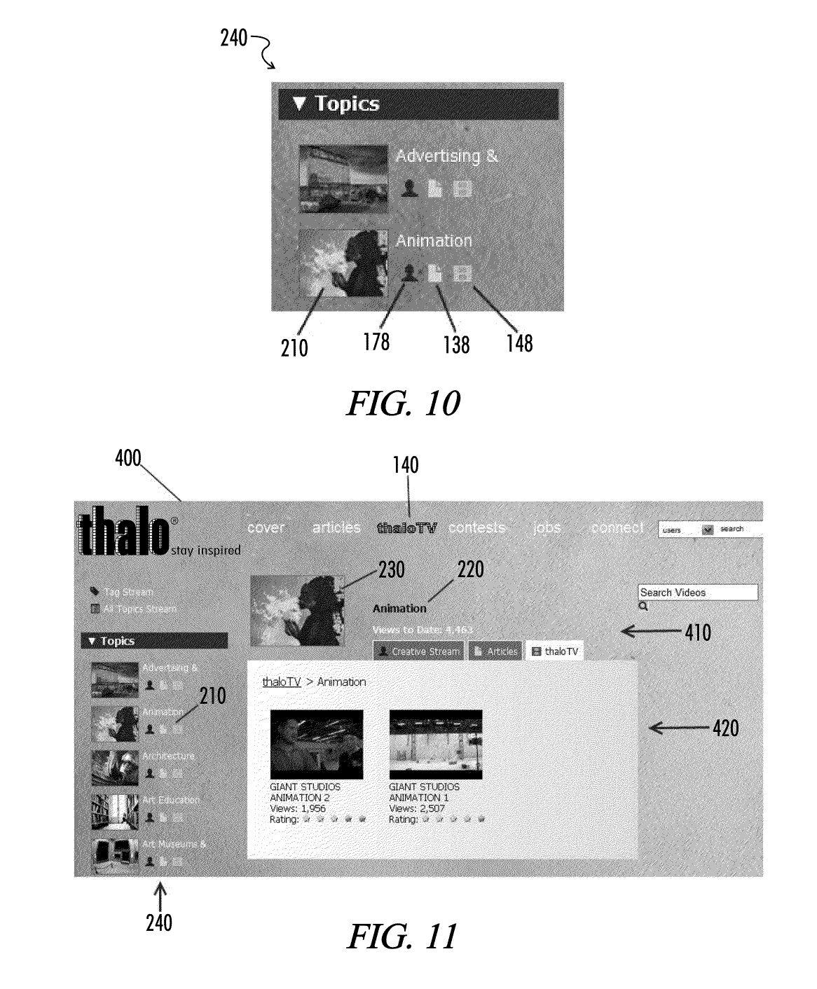

Once a user selects a particular art topic 210 with a particular primary category 100, a user is able to navigate to certain other primary categories 100 within the same art topic 210. For example, if a user initially selects articles 130 from the primary category links 100 and navigates to the articles page 132 (FIG. 5), and then the user selects animation as the art topic 210, a user will be presented with a web page 300 shown in FIG. 8, which illustrates the result of the selection of the art topic animation 210 from the articles page 132 (FIG. 5). The selection of a specific art topic 210 from the articles page will present a user with the web page 300 having an art topic header region 310 (FIG. 9) that identifies the specific art topic 210 selected by topic name 220 and topic image 230, a content region 320 including category-based (i.e. articles) content related to the specific art topic 210 selected, and an arrangement 240 of art topics 210 that provide a user with the ability to navigate to different primary categories of art topics 210 (FIG. 10). A user is able to view the various items (articles) within the content region 320 and post comments (not shown) if desired.

The topic header region 310 isolated in FIG. 9 further includes selected sub-links related to primary category links 100, or in this embodiment sub-link 174 related to primary category link connect 170, sub-link 134 related to primary category link articles 130, and sub-link 144 related to primary category link thaloTV 140. Because the user is already within the articles primary category link 130 as evidenced by the yellow color attributed to the articles primary category link 130 and, in this embodiment, the yellow highlight around the home page link 110, the articles sub-link 134 is not active and is shown in reverse highlight. These sub-links 174, 134, 144 allow a user to navigate directly to a different primary category related to the selected art topic 210, or in the illustrated embodiment, animation. This also allows a user to expeditiously peruse different primary categories of content within a specific art topic through the use of a consistent art topic header region 310 within each primary category, instead of requiring a user to first select a primary category link 100 and then select the art topic 210 related to such primary category.

So, for example, if a user selects sub-link 144 in order to view videos related to animation, a user will be presented with a web page 400 shown in FIG. 11, which illustrates the result of the selection of the art topic animation 210 from the videos page 142 (In FIG. 7). Web page 400 similarly includes an art topic header region 410 that identifies the specific art topic 210 selected by topic name 220 and topic image 230, a content region 420 including category-based content (i.e. videos) related to the specific art topic 210 selected, and the same arrangement 240 of art topics 210 that provide a user with the ability to navigate to different primary categories of art topics 210. Similarly, for example, if a user selects sub-link 174 (in FIG. 9) in order to view social network posts related to animation, for example, a user will be presented with a web page 500 shown in FIG. 17, which illustrates the result of the selection of the art topic animation 210 from the connect page 172 (FIG. 13), which will be described in more detail below. Web page 500 similarly includes an art topic header region 510 that identifies the specific art topic 210 selected by topic name 220 and topic image 230, a content region 520 including a creative stream of user posts 550 related to the specific art topic 210 selected, and the same arrangement 240 of art topics 210 that provide a user with the ability to navigate to different primary categories of art topics 210.

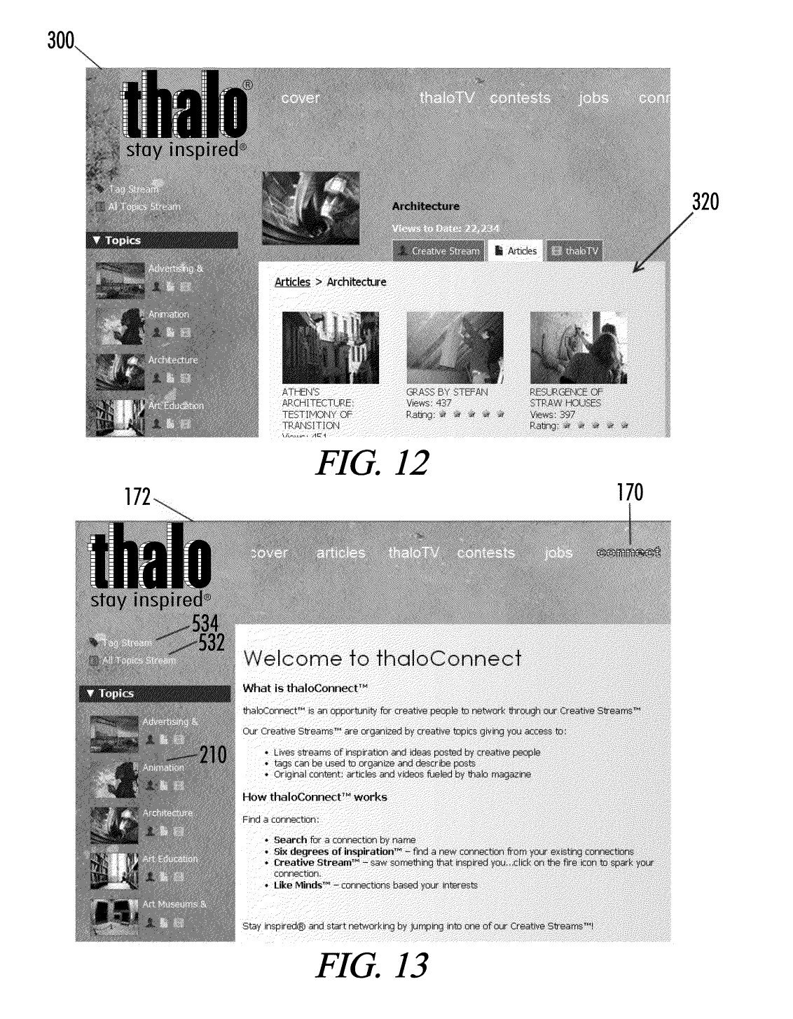

Returning now to FIGS. 8-10, each sub-link 174, 134, 144 preferably further comprises a sub-link name component that identifies a primary category name, and an associated visual component or icon 178, 138, 148. In the illustrated embodiment, the icon 178 is a person that represents an aspect of the social network primary category 170, the icon 138 is a sheet of paper that represents an aspect of the articles primary category 130, and the icon 148 is a film strip that represents an aspect of the thaloTV primary category 140. Of course, while certain icon images are used, it will be appreciated that other images may be used as desired. These icons are used in the arrangement 240 of art topics 210 that allow a user to navigate directly to a primary category of content related to the selected art topic 210. So, for example, if the user is on page 300 of FIG. 8 and is perusing articles related to the art topic of animation, and the user desires to peruse articles related to architecture, the user merely has to select the icon 138 in the architecture art topic 210 and the content region 320 of the articles page 300 will display articles related to architecture, as shown in FIG. 12.

A user is able to vary the content region 520, 320, 420, in at least one of two ways. First, if the user wants to stay within a particular art topic 210 but wishes to explore content related to a different primary link category, the user would navigate using the sub-links 174, 134, and 144 as described above. For example, if the user wanted to go from content region 320 (articles) to content region 420 (videos), the user would select sub-link 144. However, if the user wanted to switch topics and/or primary categories, the user would navigate using the icons from the arrangement 240 of art topics. For example, if the user wanted to go from viewing articles about animation (FIG. 8) to viewing videos about architecture (not shown), the user would simply select the video icon 148 in the architecture art topic from the set of topics 210 and then the user would be presented with a content region 420 indicating videos and a header region 410 indicating architecture. Similarly, if the user wanted to go from viewing videos about architecture (not shown) to viewing posts about animation (FIG. 17), the user would simply select the connect icon 178 in the animation art topic 210 and then the user would be presented with a post content region 520 and an animation header region 510. Thus, a user could use the sub-links 174, 134, and 144 within the header region 510, 310, 410 to navigate across primary category content within the same art topics, or use the icons within the arrangement 240 of art topics to navigate to a specific primary category of content within the same or different art topic. This type of navigation enables a user to vary the content region 320, 420, 520 to a different content type within the same or different art topic without having to first select a primary category link 100.

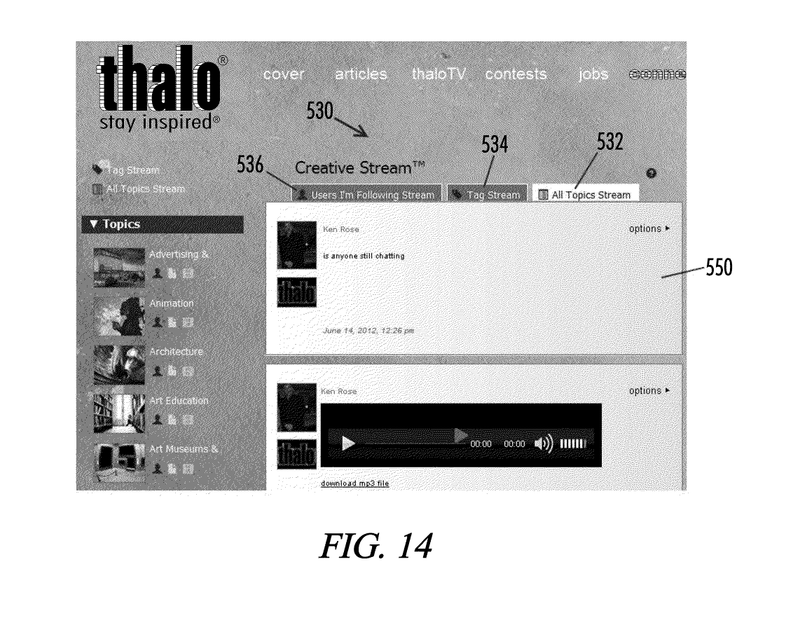

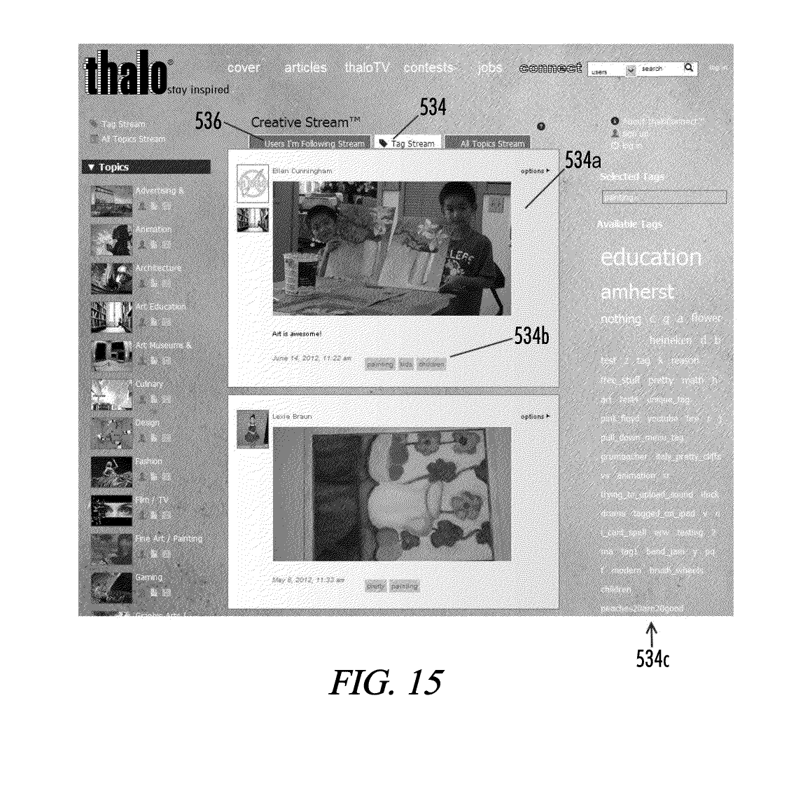

Aside from simply viewing content relating to a particular art topic 210, wherein a user is a passive participant in the exploration of art, the website 50 also provides a user with the ability to be an active participant in a community of users that appreciate art in general, and to collaborate with other users with respect to specific art topics 210. This is achieved by selecting the primary category link connect 170 that then launches a social network and brings a user to the initial connect page 172 as shown in FIG. 13. The foundation of the social network is a creative stream of ideas and content that is comprised of posts 550 from users that are arranged into a plurality of streams 530 including an all topics stream 532, a tag stream 534 and a user-specific stream 536. Other streams are possible. The all topics stream 532 (FIG. 14) includes every post 550 irrespective of the art topic, while the tag stream 534 (FIG. 15) includes posts 534a that have tags 534b selected by a user that are then exhibited in a tag region 534c. The user-specific stream 536 (not shown) includes only posts related to users that are officially connected through the social network.

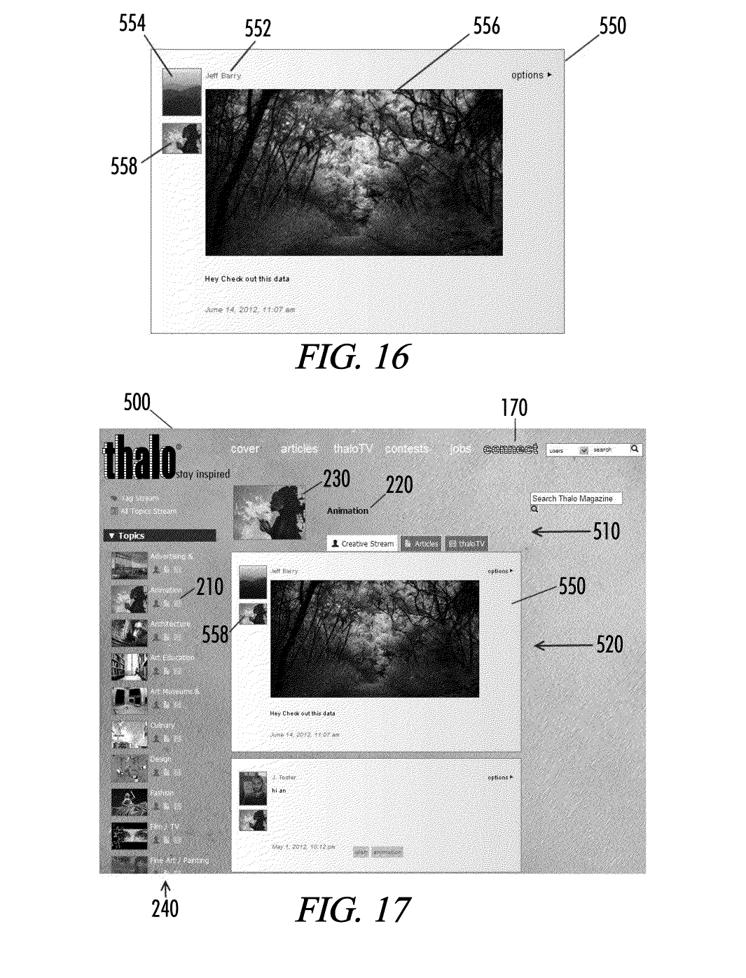

FIG. 16 illustrates an example of a post 550 comprising a user name 552, a user-selected image 554 associated with the user name 552, user-supplied content 556, and an optional location identifier 558 that identifies the location of the user at the time the user created the post 550. The social network can be accessed directly by selecting connect 170 from the primary links 100, or it can be accessed by selecting the sub-link 174 from the art topic header region 310 (FIG. 9) or region 410 (FIG. 11), or it can be accessed by selecting an icon 178 from any art topic 210 from the arrangement 240 of art topics present within a topic-specific articles page 300 (FIG. 8) or videos page 400 (FIG. 11) or a creative stream page 500 (FIG. 17). The location identifier 558 within a post 550 will be dependent on the location of the user at the time the post is submitted. If, for example, the user selects the icon 178 from the animation art topic 210 from within the arrangement 240 of art topics, then the user is taken to the webpage 500 shown in FIG. 17, and if the user posts a comment or content from the animation creative stream, then the location identifier 558 will be consistent with the corresponding art topic image 230. The location identifier 558 also functions as a link to the creative stream webpage 500 related to such art topic image 230. So, for example, if the location identifier 558 is the animation art topic image 230, then clicking on the location identifier 558 will navigate the user to the creative stream of posts 550 (FIG. 17) within the animation art topic 210.

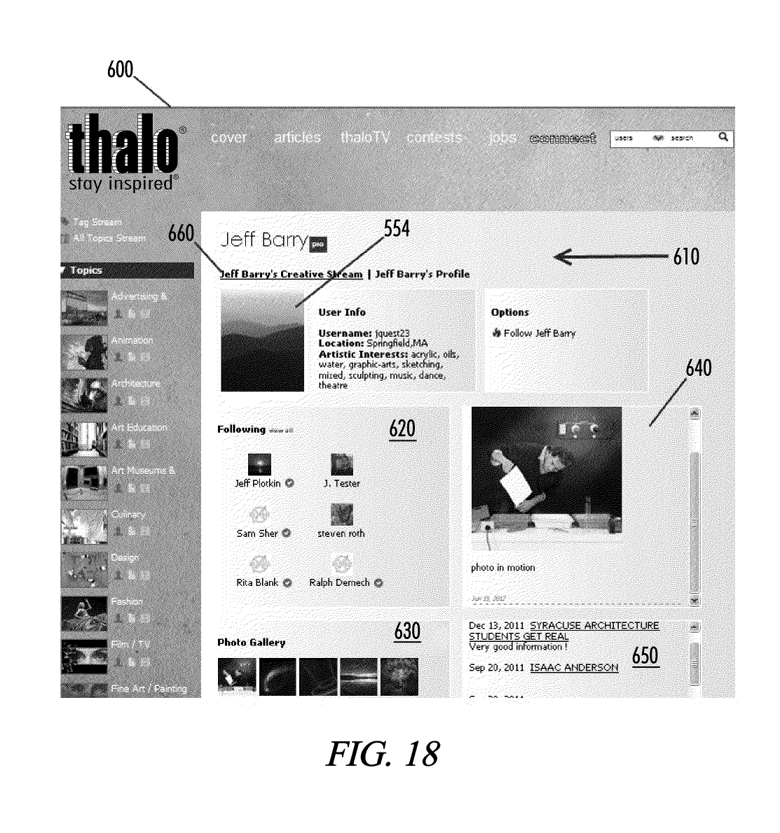

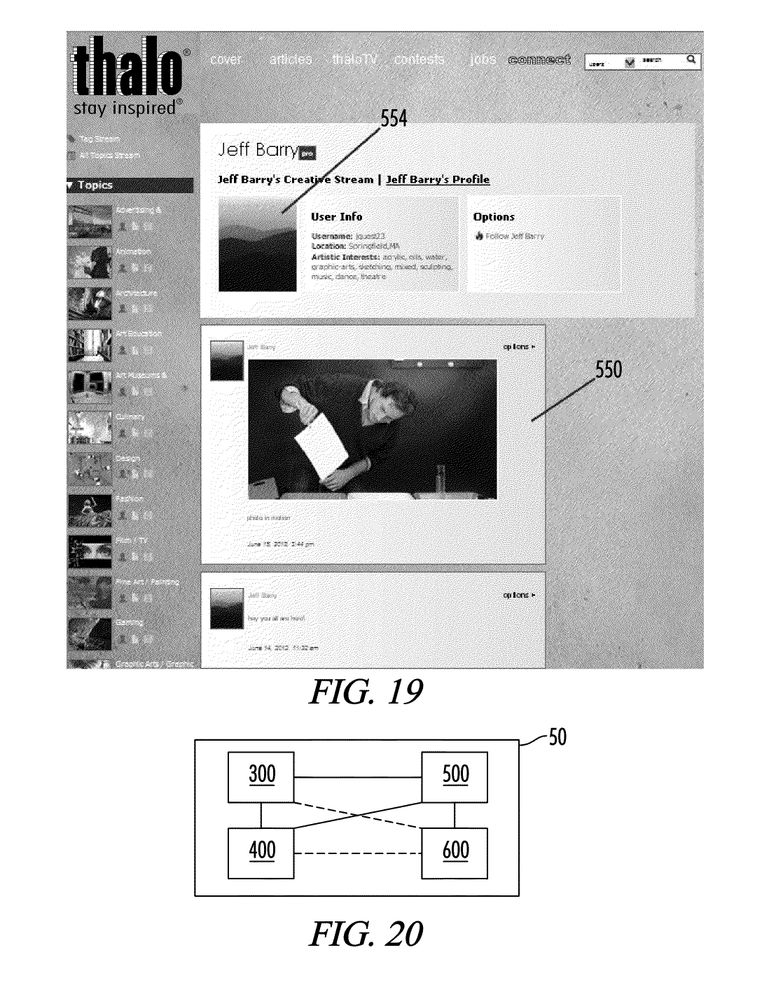

The user-selected image 554 may also function as a link to a profile page 600 of the user (FIG. 18) that illustrates a user header region 610, the user-selected image 554, a region 620 that shows other users which the current user is following, a content region 630, the user's most recent post 640, a comment region 650, and a link 660 to the user's own creative stream (FIG. 19) of content and posts that are specific to such user. Thus, if a user is inspired by a particular post 550 and wishes to experience additional or future posts 550 by the originator of the post 550, then the user simply needs to navigate to the user's profile page 600 by selecting the user-selected image 554 and follow such user with a user-specific stream 536 (see FIG. 14). Similarly, if the user is inspired by a particular post 550 and wishes to look at other posts 550 within the same art topic 210, the user simply needs to select the location identifier 558 (see FIG. 17) reflective of the art topic image 230 and then the user will navigate to the creative stream page (i.e. website 500) related to such art topic 210.

Thus, as illustrated in FIG. 20, a user is able to focus its navigation around the website 50 by art topic 210, where a user is able to shift seamlessly between the articles content page 300, videos content page 400 and creative stream page 500. Once in a creative stream 500, a user may access user profiles 600 and the like, and then the user may navigate directly to the articles content page 300, videos content page 400 and creative stream page 500. If a user is only interested in one art topic 210 for example, then the user can more efficiently navigate around the website 50 and explore content specific to the particular art topic without having to wade through art topics that are not of interest to the user.

In addition, the art topic image 230 harmonizes the user experience by functioning as
a. as an identifier of a specific art topic 210 generally,
b. an identifier of a header region 310, 410, 510 within a content page 300, 400, 500,
c. an identifier of the location when such user posts content to a creative stream or when such user posts content about a particular article or video, and
d. a navigation link to a particular creative stream if the art topic image 230 is a location identifier 558 within a post 550.
   The art topic image 230 also provides the user with a constant visual reinforcement of the user's interest and location within the website 50, and also identifies other users that might share similar interest in a particular topic through the use of the art topic image 230 as a location identifier in a post 550. Thus, if desired, a user is able to view content, connect and collaborate with others, and navigate around the website by focusing on a specific art topic image.

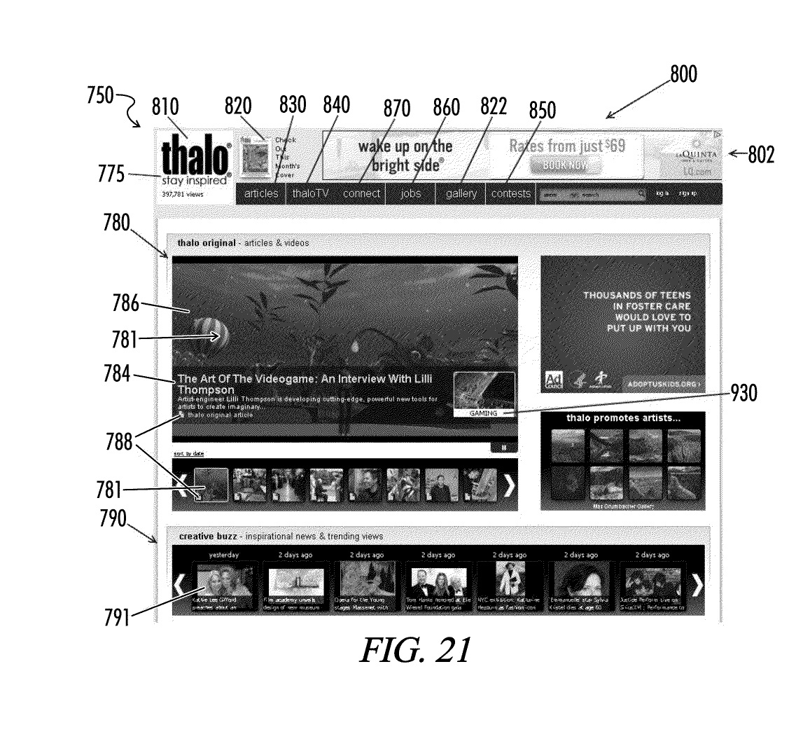

FIG. 21 illustrates an alternative embodiment of a portion of a home page 775 of a website 750 that is operated on a server or the like and that is accessed by a user through a network, where the website 750 that will be used for purposes of explaining an alternative embodiment of the method of the present disclosure will be shown as a next generation version of the website, as compared with the embodiment of the generation of FIGS. 1A-20, of Thalo® magazine found at www.thalo.com. While one particular website is being used for purposes explanation, it will be appreciated that the content and the arrangement of elements is not meant to be limiting, but is meant to be merely illustrative, and that other content or arrangements are possible. Furthermore, while a network is described, it will be appreciated that any type of local or global network may be used. Furthermore, while a server is described, it will be appreciated that any type of device may be used without detracting from the functionality of the website 750 or the scope of the present disclosure.

As described in the previous embodiment of FIGS. 1A-20, the website 750 of the alternative embodiment of FIG. 21 is also a computer-implemented system that is an exploration of the arts that provides categories of exploration including static content such as articles, dynamic content such as video, various databases of contests and jobs, for example, and a social network that allows users to connect and network with each other. The website is operable on a computer system comprising a processing system and one or more computers coupled to the processing system over a network or the like. More specifically, the home page 775 illustrates a plurality of primary category links 800 shown in the present embodiment as a home page link 810, a cover link 820, articles 830, thaloTV 840, connect 870, jobs 860, gallery 822, and contests 850. The particular primary category links 800 illustrated and described herein are not meant to be limiting, but are only provided for purposes of explanation. In particular:
a. the link marked thalo 810 takes the user back to the home page 775 and will, for purposes of convenience, be described from this point forward as a home page link 810,
b. cover 820 takes the user to a cover page (not shown) that illustrates content (not shown) related to a magazine (not shown) associated with the owner of the website 750,
c. articles 830 takes a user to an articles page for the selection of static content such as articles,
d. thaloTV 840 takes a user to a videos page for the selection of dynamic content such as videos,
e. connect 870 takes the user to a social network via a social network page,
f. jobs 860 takes the user to a jobs page for the selection of jobs,
g. gallery 822 takes the user to a third party website (not shown) that preferably has a relationship with the owner of the website 750, such as a contractual relationship or a website linking agreement relationship wherein the third party website can enjoy the benefit of being featured with a direct link on the website 750, and
h. contests 850 takes the user to a contests page for the selection of contest.
   These primary links 800 generally reside in a primary category link header region 802 that, in the present embodiment of FIG. 21, presents a user with a unique navigation experience upon selection of certain select primary links 800.

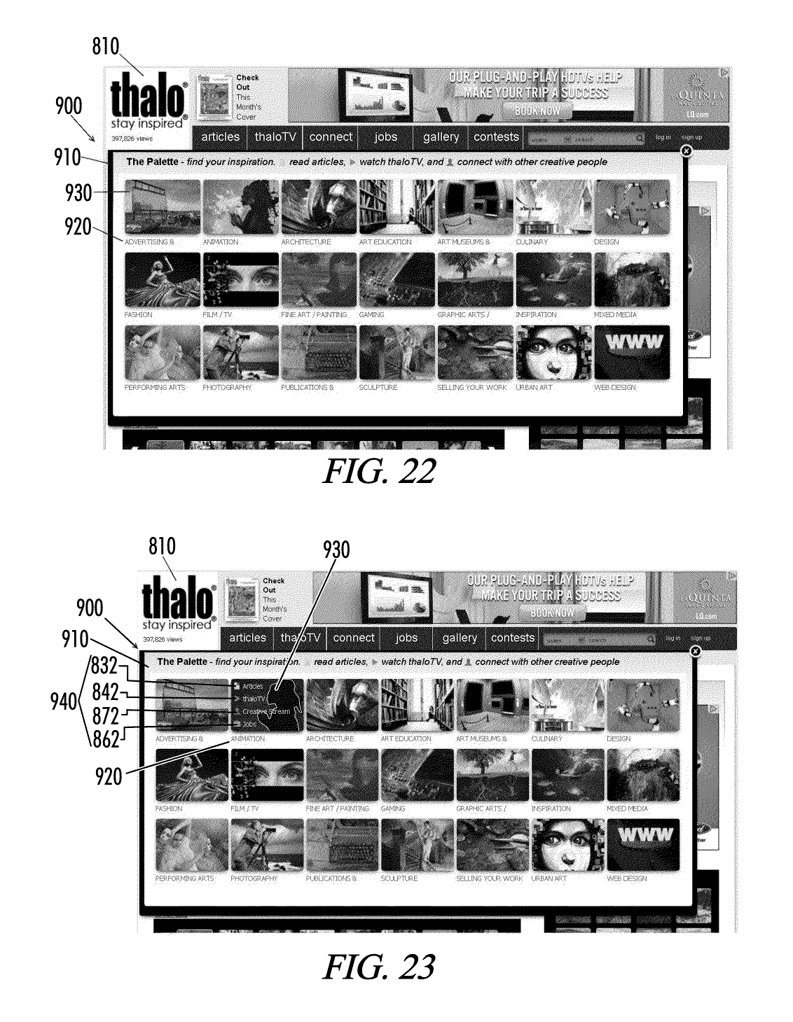

In accordance with one embodiment as shown in FIG. 22, navigation over the home page link 810 without a user's selection of the same results in the presentation of a mini arrangement 900 of art topics 910 defined by art topic names 920 and art topic images 930 that are similar to the previously described art topics 210 of matrix 200 of the previously described embodiment, it being understood that the illustrated order, arrangement and subject matter of the topics 910 are not meant to be limiting but can be varied as desired. In accordance with one embodiment as shown in FIG. 23, navigation over any of the art topics 910 presented within the mini-arrangement 900 revealed by the home page link 810 results in the presentation of an arrangement 940 of primary category sub-links such as Articles 832, thaloTV 842, Creative Stream 872 and Jobs 862, each of which functions as a shortcut to the primary category content related to such selected art topic. This arrangement 940 illustrated in FIG. 23 is similar to the arrangement 240 shown in the previously-described embodiment of FIG. 11, for example, but in the case of the arrangement 940 of FIG. 23, the primary category sub-links are presented within the art topic image 930 preferably as a highlighted overlay on top of the art topic image 930 (wherein the art topic image 930 in the present embodiment is partially shaded out) instead of positioned adjacent the art topic image 230 as shown, for example, in the embodiment of FIG. 11. The positioning of the arrangement 940 of primary category sub-links within the art topic image 930 creates an efficient use of space and enables a user to intuitively navigate to a particular primary category of content without leaving the borders of the art topic image 930, which reinforces the user's placement and positioning within the art topic image 930 and the art topic overall.

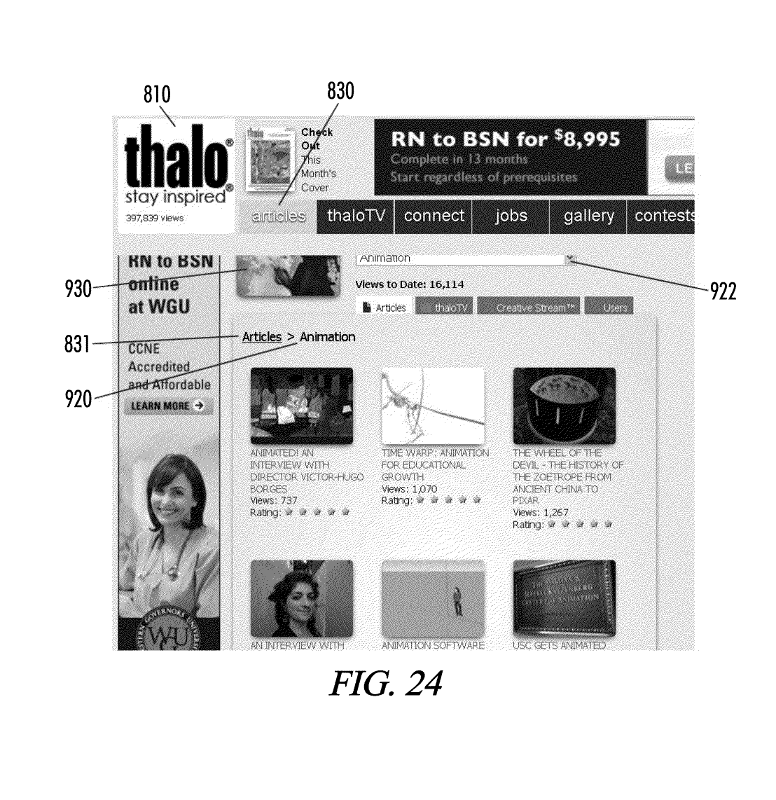

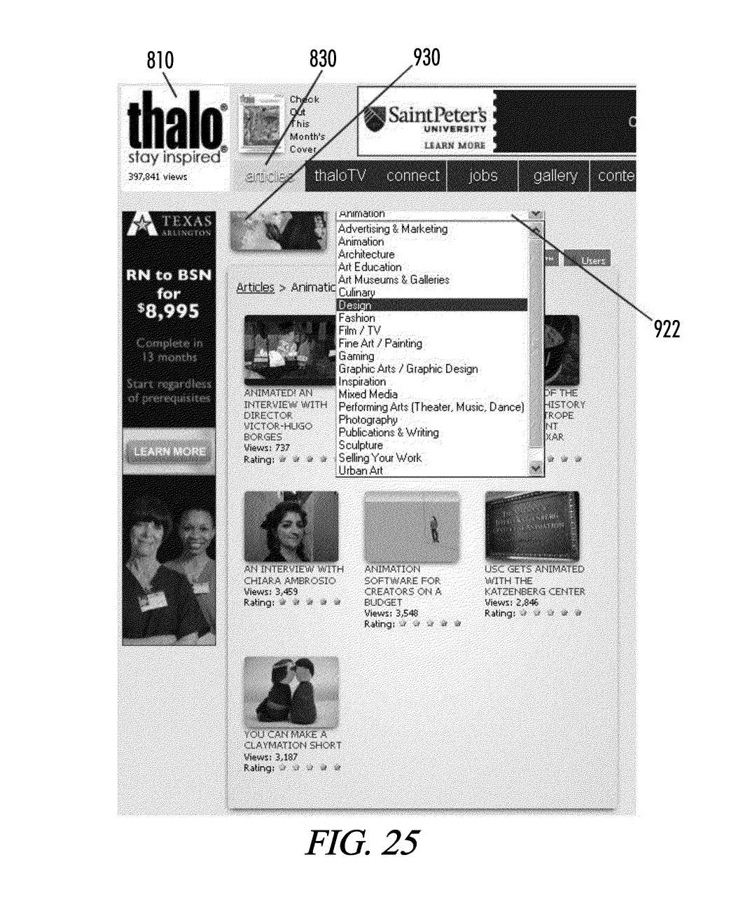

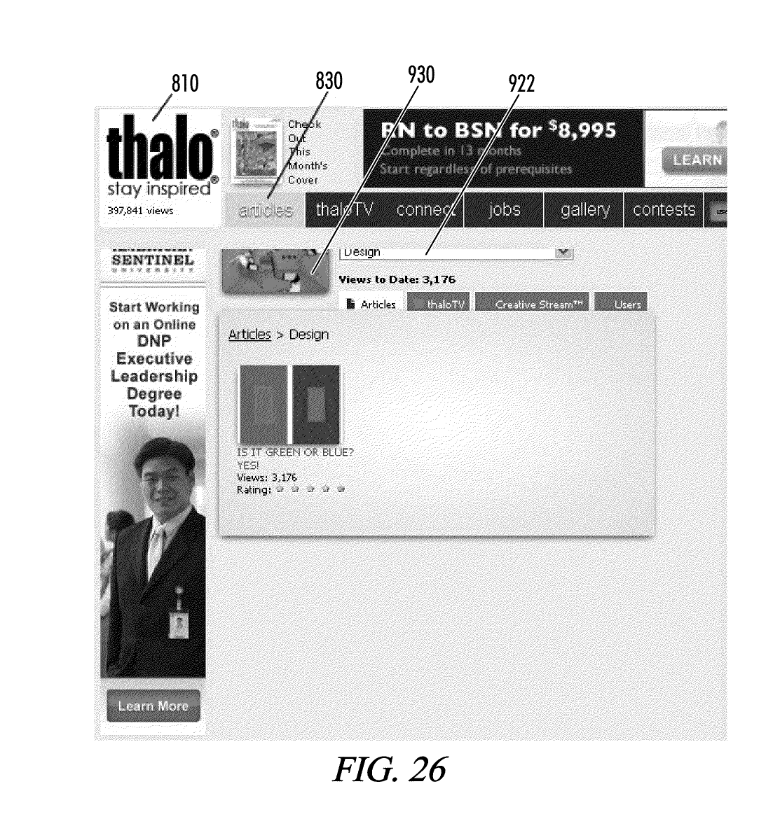

For example, in the embodiment of FIG. 23, a user first navigated over the home page link 810 and then navigated to the Animation art topic 910, and if the user desires to review all articles associated with the Animation art topic 910, the user would select the Articles 832 sub-link and navigate directly to the Animation-based articles page as shown in FIG. 24. A user is provided with one form of confirmation that the user is within the articles primary category link 830 by the change in appearance of the articles primary category link 830. In one embodiment, for example, the change in appearance is visual such as a change of color, font color, background color, or a combination of the same, or in the example of FIG. 24 the articles link 830 changes to the color yellow. For additional confirmation, the user also sees the name 831 of the primary category link 830, the topic name 920, and the topic image 930. In addition, the user may be presented with a further navigation tool such as a drop-down menu 922 that allows a user to change art topic within the selected primary category such as, for example, the selection of the Design art topic as shown in FIG. 25, which brings the user to the Design-based articles as shown in FIG. 26.

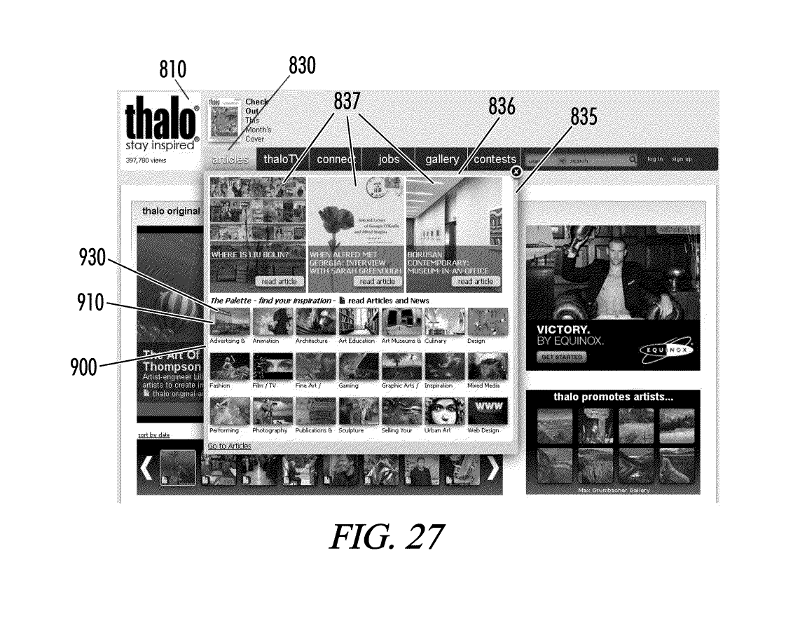

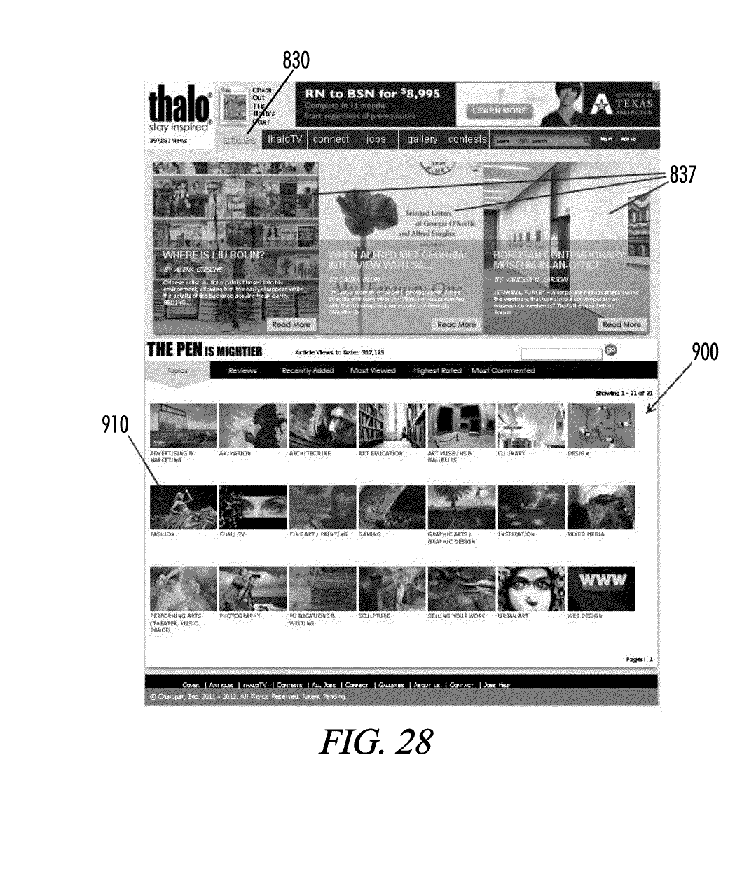

Thus, in the embodiment of FIGS. 22-26, a user is able to navigate to content within an art topic by first navigating to the home page link 810, then to the art topic 910, then to the content category arrangement 940 within the art topic. A more focused and directed navigation scheme is also realized when the user navigates over certain primary category links such as articles 830, thaloTV 840, connect 870, or jobs 860. For example, as shown in FIG. 27, when a user navigates over articles 830, the user is presented with a snapshot 835 of content including primary articles 837 and a mini-arrangement 900 of art topics 910 that would be presented to the user had the user selected, rather than navigated over, the primary category link for articles 830 as shown in FIG. 28. Thus, instead of the user accessing content by having to first select articles 830 and then having to select a particular art topic, which would require two separate selections, the user can be presented with a snapshot 835 upon navigation over the articles 830 primary category link and then jump directly to a primary article 837 or to articles within a particular art topic 910 by selecting the art topic image 930 within the snapshot 835. Thus, a user is able to access content with a single selection.

The snapshot 835 of FIG. 27 further comprises a border 836 that has a unique visual aesthetic that is also consistent with an aesthetic assigned to the primary category link. In the embodiment of FIG. 27, for example, the snapshot 835 is surrounded by a distinguishing border 836 that is colored the same as the color of the primary articles category link 830, which is yellow in the present embodiment. This unique aesthetic (i.e. yellow highlighted “articles” and a yellow border around the snapshot 835) reinforces to the user that the user is viewing articles instead of another type of content such as videos or dynamic content. The visual characteristic of the snapshot and the primary category link, or in this case a certain color outline, preferably varies with the selection of primary category link so that a user is able to easily ascertain its location relative to a certain primary link. In this example, the snapshot 835 assumes a consistent visual characteristic (i.e. colored border 836) as the visual characteristic of the articles link 830 (i.e. colored background), although it is possible for the selected primary link to also assume the same visual characteristic, or a colored outline in this case. In one example (not shown), the home page link 810 can assume a different color or color outline depending on the primary category link 830-870 (see FIG. 21) selected. For example, the “thalo” term may have a yellow outline or change from a white to a yellow background when articles 830 is selected, which preferably results in the “articles” term assuming the same yellow color as the yellow color outline around “thalo.”

The visual characteristic of color and the manner of expression being a font outline color or a change in background, etc., can be manifested in a variety of ways depending on the selection of the primary category link. In addition, it will be appreciated that other visual characteristics are possible, such as font color, font type, font language, font texture, font case (lowercase or upper case, for example), font size, font appearance (i.e. bold, underline, strikeout, etc.), a toggle between certain fonts or font types, the use of an image, or an icon, or various combinations of the above. It is preferable for a reinforcing visual characteristic to be unique to each primary category link so that, for example, the articles link 830 has one unique color background or outline (such as yellow, for example). It is also preferable if the visual characteristic is not repeated for different primary category link selections so that a user is able to ascertain its location by viewing the primary category link and associate a visual characteristic with a particular type of content so that the user can more efficiently navigate around the website without being districted by content that is not of interest to the user.

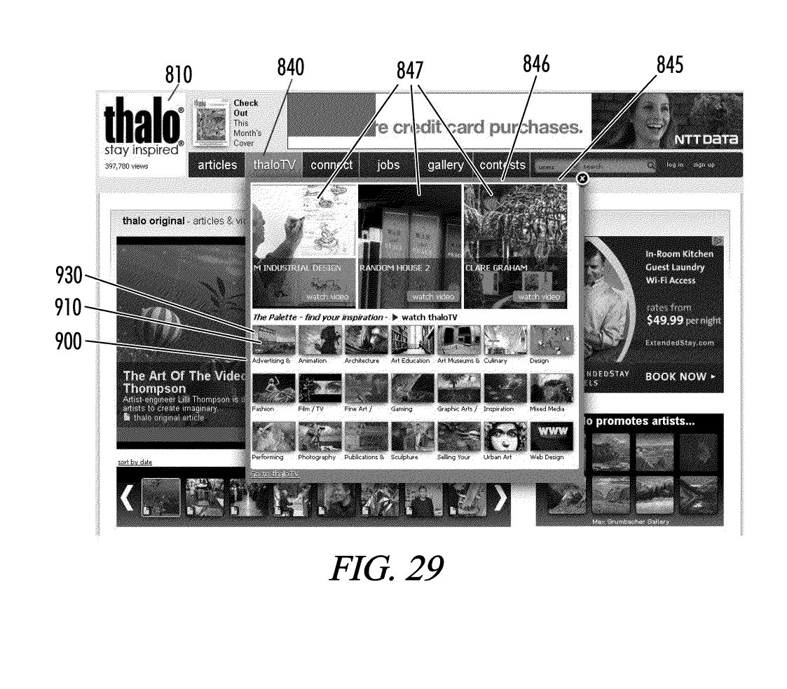

Similar to that demonstrated in FIG. 27, as shown in FIG. 29, when a user navigates over thaloTV (videos) 840, the user is presented with a snapshot 845 of content including primary videos 847 and a mini-arrangement 900 of art topics 910 that would be presented to the user had the user selected, rather than navigated over, the primary category link for thaloTV 840. The snapshot 845 has a unique visual aesthetic that is also consistent with an aesthetic assigned to the primary category link 840. In the embodiment of FIG. 29, for example, the snapshot 845 is surrounded by a distinguishing border 846 that is colored the same as the color of the primary thaloTV category link 840, which is red in the present embodiment. This unique aesthetic (i.e. red highlighted “thaloTV” and a red border around the snapshot 845) reinforces to the user that the user is viewing videos instead of another type of content such as articles. Furthermore, instead of the user accessing content by having to first select thaloTV 840 and then having to select a particular art topic, which would require two separate selections, the user can be presented with a snapshot 845 upon navigation over the thaloTV 840 primary category link and then jump directly to a primary video 847 or to videos within a particular art topic 910 by selecting the art topic image 930 within the snapshot 845. Thus, a user is able to access content with a single selection.

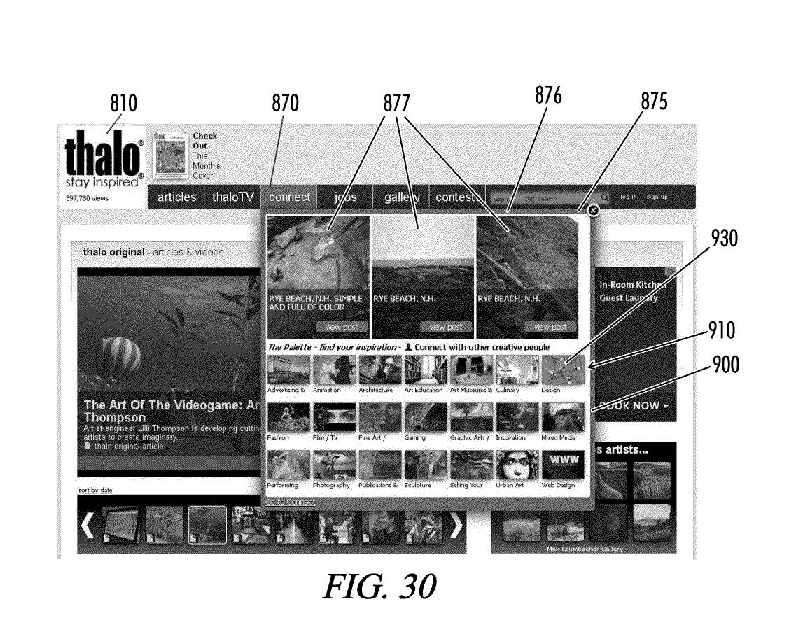

Similar to that demonstrated in FIGS. 27 and 29, as shown in FIG. 30, when a user navigates over connect (social network) 870, the user is presented with a snapshot 875 of content including posts 877 and a mini-arrangement 900 of art topics 910 that would be presented to the user had the user selected, rather than navigated over, the primary category link for connect 870. The snapshot 875 has a unique visual aesthetic that is also consistent with an aesthetic assigned to the primary category link 870. In the embodiment of FIG. 30, for example, the snapshot 875 is surrounded by a distinguishing border 876 that is colored the same as the color of the primary category link 870, which is blue in the present embodiment. This unique aesthetic (i.e. blue highlighted “connect” and a blue border around the snapshot 875) reinforces to the user that the user is viewing posts instead of another type of content such as articles or videos. Furthermore, instead of the user accessing content by having to first select connect 870 and then having to select a particular art topic, which would require two separate selections, the user can be presented with a snapshot 875 upon navigation over the connect 870 primary category link and then jump directly to a primary post 877 or to posts within a particular art topic 910 by selecting the art topic image 930 within the snapshot 875. Thus, a user is able to access content with a single selection.

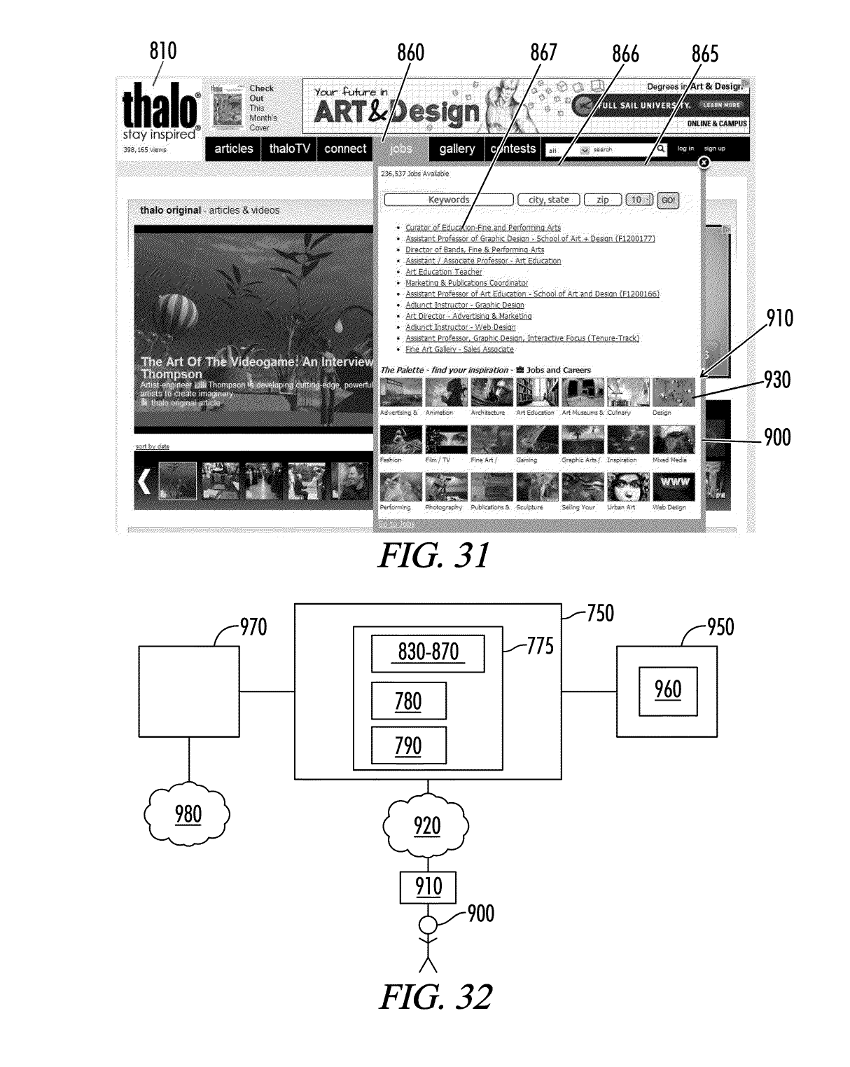

Similar to that demonstrated in FIGS. 27, 29 and 30, as shown in FIG. 31, when a user navigates over jobs (job postings) 860, the user is presented with a snapshot 865 of content including job postings 867 and a mini-arrangement 900 of art topics 910 that would be presented to the user had the user selected, rather than navigated over, the primary category link for jobs 860. The snapshot 865 has a unique visual aesthetic that is also consistent with an aesthetic assigned to the primary category link 860. In the embodiment of FIG. 31, for example, the snapshot 865 is surrounded by a distinguishing border 866 that is colored the same as the color of the primary category link 860, which is green in the present embodiment. This unique aesthetic (i.e. green highlighted “jobs” and a green border around the snapshot 865) reinforces to the user that the user is viewing job posts instead of another type of content such as articles or videos. Furthermore, instead of the user accessing content by having to first select jobs 860 and then having to select a particular art topic, which would require two separate selections, the user can be presented with a snapshot 865 upon navigation over the jobs 860 primary category link and then jump directly to a primary job posting 867 or to posts within a particular art topic 910 by selecting the art topic image 930 within the snapshot 865. Thus, a user is able to access content with a single selection.

Returning now to FIG. 21, the home page 775 further comprises additional areas of content including at least a first content reel 780 defined by thumbnail-sized images 781 that are individually and more completely highlighted in a feature area 782 and that are representative of either an article or video that is designated by a title 784, an image 786, an icon 788 and associated art topic image 930. The first content reel 780 is preferably populated with content from the website 750 that is retrieved or otherwise accessed by accessing one of the primary categories on the home page 775, and more preferably either the articles link 830 or the thaloTV (videos) link 840. The icons 788 are strategically placed in the thumbnail-sized image and in the feature image 786 to reinforce the type of content and whether such content is an article (static content) or video (dynamic content). In addition, the title 784 of the image 786 includes an aesthetic feature that is also consistent with the type of content, whereas in the example of FIG. 21, the title 784 and the icon 788 are each the same color (such as yellow, for example), which is also representative of articles as described in connection with FIGS. 27-28. Thus, the aesthetic applied to the title 784 and the icon 788 reinforces the consistent association between the type of content (i.e. articles or videos) and its positioning within the website 750. Furthermore, the positioning of the art topic image 930 over the feature image 786 also reinforces the association of the content with the art topic genre, which allows users having a particular interest with a particular art type or genre to focus in on and selectively ingest content of particular interest to such user. Simply identifying a feature image 786 by a title 784 may not be sufficient to identify the art type or genre to a grazing user, and the incorporation of the art topic image 930 onto the feature image 786 allows a user to target content that is aligned with the user's interests. In addition, the art topic image 930 functions as a navigation link that, upon being activated, will take the user to the category of content associated with the art topic image 930 and the icon 788, or in the case it will take the user to articles (icon 788) related to gaming (art topic image 930). The home page 775 further comprises at least a second content reel 790 defined by thumbnail-sized images 791 that are that are representative of content generated or obtained from outside the website 750, such as from third party news or media sources. In the illustrated embodiment, the second content reel 790 is not associated with certain primary category links on the website 750 like with the first content reel 780 because the content from the second content reel 790 is preferably not resident within the website 750 or accessed through either the articles link 830 or the thaloTV (videos) link 840. The second content reel 790 preferably includes links to sources not directly associated with the website 750.

FIG. 32 illustrates one diagrammatic view of the arrangement of the home page 775 of the website 750 that is accessible by a user 900 through a user device 910 connected to a network 920, wherein the website 750 resides in a storage media such as a server 950, for example, and wherein the server further comprises a database of internal content 960 that is used to populate the substantive sections of the website 750 that are accessed through the primary links 830-870 and to populate the first content reel 780. Content 970 from news and media sources outside of the website 750 are also fed into the website 750 through a network 980 or the like to populate certain sections of the website 750 including the second content reel 790 for example. Thus, content featured on the website 750 and on the home page 775 that is resident internally is also designated and classified through the use of visual aesthetics and associations to subject matter categories and genres through the use of art topic images and the like. Whereas, content featured on the website 750 and on the home page 775 that is obtained from outside sources is separately identified on the home page 775 and lacks the visual aesthetics to associate the content with subject matter categories and genres through the use of art topic images and the like.

Embodiments of the subject matter and the operations described in this specification can be implemented in digital electronic circuitry, or in computer software, firmware, or hardware, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The term “computer system” or “computer-based method” as used in the specification and claims encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The block diagrams in the different depicted embodiments illustrate the architecture, functionality, and operation of some possible implementations of apparatus, methods and computer program products that might incorporate the method of the present disclosure. In this regard, each block in a flowchart or block diagram or an element of a website or the like may represent a module, segment, or portion of code, which comprises one or more executable instructions for implementing the specified function or functions. In some alternative implementations, the function or functions noted in a block may occur out of the order noted in the figures. For example, in some cases, two blocks shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain or store the program for use by or in connection with the instruction execution system, apparatus, or device. The medium is tangible, and it can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code for performing the method of the invention will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A computer-based method of organizing and accessing information on a website, comprising:
a) providing a plurality of primary category links on a website associated with a plurality of primary categories;
b) providing a plurality of topic links each associated with one or more art topics, each topic link having a topic name and a topic image; and
c) providing a content region for presenting content for an art topic and having a content type associated with a primary category;
d) wherein the content region may be changed to a different content type within the same or to a different art topic without having to first select a primary category link.

2. The method of claim 1, wherein the primary category links further comprise static content, dynamic content and a social network.

3. The method of claim 2, wherein the static content includes articles and the dynamic content includes videos.

4. The method of claim 1, wherein the art topics further comprise at least one of advertising and marketing, animation, architecture, art education, art museums and galleries, culinary, design, fashion, film and television, fine art and painting, gaming, graphic arts and graphic design, inspiration, mixed media, performing arts (theater, music dance), photography, publications and writing, sculpture, selling your work, urban art and web design.

5. The method of claim 4, wherein the topic links are arranged in a matrix.

6. The method of claim 5, wherein the same matrix is presented upon the selection of each of the plurality of primary category links.

7. The method of claim 5, wherein the same matrix is presented upon the selection of each, but not all, of the plurality of primary category links.

8. The method of claim 1, further comprising a home page link that navigates a user to the home page, and wherein the home page link assumes a certain visual characteristic depending on the primary category link selected.

9. The method of claim 8, wherein the visual characteristic of the home page link varies with the primary category link.

10. The method of claim 9, wherein the selected primary link assumes the same visual characteristic as the visual characteristic of the home page link.

11. The method of claim 10, wherein the visual characteristic of the home page link is unique to each primary category link.

12. The method of claim 8, wherein the visual characteristic of the home page link includes one of font outline, font color, font type, font language, font texture, font case (lowercase or upper case, for example), font size, font appearance (i.e. bold, underline, strikeout, etc.), a toggle between certain fonts or font types, or various combinations of the above.

13. The method of claim 1, wherein the primary category links are provided in a primary category link header region that further comprises a home page link that navigates a user to the home page, and wherein the user's location in the website is ascertainable with reference to the appearance of the home page link.

14. The method of claim 13, wherein the home page link assumes a certain visual characteristic depending on the primary category link selected.

15. The method of claim 1, wherein the primary category links further comprises a social network and the content region is a post or a collection of posts, each post identifying a user and exhibits user-supplied content.

16. The method of claim 15, wherein the post further comprises a location identifier that identifies the location of the user at the time the post is created.

17. The method of claim 16, wherein the location identifier further comprises the topic image.

18. The method of claim 17, wherein the topic image functions as a navigation link.

19. The method of claim 1, wherein the topic image functions as a navigation link.

20. The method of claim 1, wherein the topic image functions as a navigation identifier.

21. A computer-based method of organizing and accessing information on a website, comprising:
a) providing a plurality of primary category links associated with a plurality of primary categories;
b) providing a plurality of topic links each associated with one or more art topics, each topic link having a topic name and a topic image; and
c) presenting the plurality of topic links in a consistent arrangement for each primary category upon navigation over the associated primary category link.

22. The method of claim 21, wherein the primary category links further comprise static content, dynamic content and a social network.

23. The method of claim 22, wherein the static content includes articles and the dynamic content includes videos.

24. The method of claim 21, wherein the art topics further comprise at least one of advertising and marketing, animation, architecture, art education, art museums and galleries, culinary, design, fashion, film and television, fine art and painting, gaming, graphic arts and graphic design, inspiration, mixed media, performing arts (theater, music dance), photography, publications and writing, sculpture, selling your work, urban art and web design.

25. The method of claim 24, wherein the topic links are arranged in a matrix.

26. The method of claim 25, wherein the same matrix is presented upon the selection of each of the plurality of primary category links.

27. The method of claim 25, wherein the same matrix is presented upon the selection of each, but not all, of the plurality of primary category links.

28. The method of claim 21, further comprising a home page link that navigates a user to the home page, and wherein navigation over the home page link presents the plurality of topic links in an arrangement that is consistent with the arrangement for each primary category link.

29. The method of claim 21, further comprising a snapshot aesthetic associated with the arrangement for each primary category link.

30. The method of claim 29, wherein the snapshot aesthetic further comprises a colored border that is unique to each primary category.

31. A computer-based method of organizing and accessing information on a website, comprising:
a) providing a plurality of primary category links associated with a plurality of primary categories;
b) providing a plurality of topic links each associated with one or more art topics, each topic link having a topic name and a topic image; and
c) incorporating at least one navigation link within a topic image that enables navigation to a primary category of content related to the art topic of the topic image.

32. The method of claim 31, further comprising incorporating a plurality of navigation links within a topic image that enables navigation to a plurality of primary categories of content related to the art topic of the topic image.

33. The method of claim 32, wherein the navigation links further comprise links to articles, videos, social networking posts or job postings.

34. The method of claim 32, wherein the navigation links further comprise links to articles, videos, social networking posts and job postings.

35. A computer-based method of presenting information on a website comprising:
a) providing a plurality of categories of content each having a category identifier;
b) providing a plurality of topic links each associated with one or more art topics, each topic link having a topic name and a topic image; and
c) incorporating at least one topic link and at least one category identifier onto an image to identify the art topic and the category associated with the image.

36. The method of claim 35, wherein the category identifier is an icon.

37. The method of claim 36, wherein the image further comprises a title and wherein the title of the image and the category identifier has a consistent appearance.

38. The method of claim 37, wherein the topic image includes a navigation link associated with the category identifier and the art topic associated with the topic image.

39. The method of claim 38, further comprising a thumbnail version of the image that incorporates the same category identifier as incorporated onto the image.

40. The method of claim 35, further comprising a plurality of different content each provided with a category identifier.

41. The method of claim 35, wherein the topic image functions as a navigation link.

42. The method of claim 41, wherein the topic image functions as a navigation identifier.

43. A computer system for organizing and accessing information on a website comprising:
a) a processing system; and
b) one or more computers coupled to the processing system over a network, wherein the processing system is configured to:
c) provide a plurality of primary category links associated with a plurality of primary categories;
d) provide a plurality of topic links each associated with one or more art topics, each topic link having a topic name and a topic image; and
e) present the plurality of topic links in a consistent arrangement for each primary category upon navigation over the associated primary category link.

44. A computer system for organizing and accessing information on a website comprising:
a) a processing system; and
b) one or more computers coupled to the processing system over a network, wherein the processing system is configured to:
c) provide a plurality of primary category links associated with a plurality of primary categories;
d) provide a plurality of topic links each associated with one or more art topics, each topic link having a topic name and a topic image; and
e) incorporate at least one navigation link within a topic image that enables navigation to a primary category of content related to the art topic of the topic image.

45. A non-transitory computer-readable medium that stores instructions executable by one or more processors to:
a) provide a plurality of primary category links associated with a plurality of primary categories;
b) provide a plurality of topic links each associated with one or more art topics, each topic link having a topic name and a topic image; and
c) incorporate at least one navigation link within a topic image that enables navigation to a primary category of content related to the art topic of the topic image.

46. A non-transitory computer-readable medium that stores instructions executable by one or more processors to:
a) provide a plurality of primary category links associated with a plurality of primary categories;
b) provide a plurality of topic links each associated with one or more art topics, each topic link having a topic name and a topic image; and
c) present the plurality of topic links in a consistent arrangement for each primary category upon navigation over the associated primary category link.
